(19) United States
(12) Patent Application Publication
(10) Pub. No.: US 2018/0078060 A1
(43) Pub. Date: Mar. 22, 2018

(54) 3D BEDDING SYSTEM

(71) Applicant: FRANCO MANUFACTURING CO. INC., Metuchene, NJ (US)

(72) Inventor: Hugo Washington Perez, Ramsey, NJ (US)

(21) Appl. No.: 15/707,987

(22) Filed: Sep. 18, 2017

Related U.S. Application Data
(60) Provisional application No. 62/396,706, filed on Sep. 19, 2016.

(51) Int. Cl. A47G 9/02; A47G 9/10; B44C 3/02; B44C 3/12; B44C 5/06; B44F 7/00

(52) U.S. Cl. CPC A47G 9/0207; A47G 9/0253; A47G 9/1045; B44F 7/00; B44C 3/12; B44C 5/06; B44C 3/025

(57) ABSTRACT

A bedding system includes a comforter having one or more first three-dimensional elements, a sham pillow having one or more second three-dimensional elements, a throw pillow having one or more third three-dimensional elements and a body pillow having one or more fourth three-dimensional elements. Each of the comforter, the sham pillow, the throw pillow and the body pillow is shaped like a character. Further, each of the one or more first three-dimensional elements, each of the one or more second three-dimensional elements, each of the one or more third three-dimensional elements and each of the one or more fourth three-dimensional elements, is an attribute of the character.

### CROSS-REFERENCE TO RELATED APPLICATIONS

This application claims the benefit of U.S. Provisional Patent Application Ser. No. 62/396,706, filed on Sep. 19, 2016, the entire content of which is hereby incorporated by reference in its entirety.

### FIELD OF INVENTION

Embodiments of the present invention generally relate to a bedding system having appendages and shaped like a character so that such a bedding system may be aesthetically appealing.

### BACKGROUND

A bedding system usually consists of a bed sheet, quilts, comforters, and a number of pillows with pillowcases. Bedding is the material laid above the mattress of a bed for hygiene, warmth, protection of mattress, and decorative effect. Bedding is the removable and washable portion of a human sleeping environment. Generally, children and some adults decorate their bed with plush stuffed animals, dolls, and other soft toys. These are not included under a bedding system, although they may provide additional warmth and comfort to the sleeper.

Pillows are designed to provide support and comfort to the body and head. Additionally, pillows have decorative uses and are used on beds, couches or chairs. A comforter is a bed cover, which is used like a blanket. The comforter is typically paired with a bed skirt to form a complete ensemble, as the comforter's sides only go about halfway to the floor. Further, the comforter may be reversible and machine washable.

Ordinary pillows include a filling placed in a casing, and provide comfort and support to the body, arms and head of a person or an animal. Aesthetically pleasing pillows also may serve as decoration to a room or house. Pillows (such as those including a pillow sham) and throw pillows, are mainly used for decoration. Aesthetically pleasing bedding systems make the bed look attractive and more comfortable to the sleeper.

Existing state of the art includes references in which a bedding system includes comforters and a number of pillows. Comforters and different pillows resembling various fictional characters and/or animals are also available. However, comforters and different pillows have purely functional configurations and shapes.

### SUMMARY

Embodiments disclosed herein relate to a three-dimensional (3D) bedding system comprising a comforter, a pillow sham, a body pillow and a throw pillow. The comforter, the pillow sham, the body pillow and the throw pillow resemble a fantasy character, a pet or an animal character, and are provided with appendages. The appendages are arms, eyes, ears and/or legs of the fantasy character, pet or animal character. Further, the appendages aesthetical match the bedding system in terms of the fantasy character, pet or animal character. The appendages are also detachable.

Embodiments in accordance with the present invention are directed to a bedding system comprising a comforter having one or more first three dimensional elements, a pillow sham having one or more second three-dimensional elements and a throw pillow having one or more third three-dimensional elements. Each of the comforter, the pillow sham and throw pillow is shaped like a character. Further, each of the one or more first three-dimensional elements, each of the one or more second three-dimensional elements, and each of the one or more third three-dimensional elements, is an attribute of the character.

Embodiments in accordance with the present invention are directed to a bedding system comprising a comforter having one or more first three-dimensional elements, a pillow sham having one or more second three-dimensional elements, a throw pillow having one or more third three-dimensional elements and a body pillow having one or more fourth three-dimensional elements. Each of the comforter, the pillow sham, the throw pillow and the body pillow is shaped like a character. Further, each of the one or more first three-dimensional elements, each of the one or more second three-dimensional elements, each of the one or more third three-dimensional elements and each of the one or more fourth three-dimensional elements, is an attribute of the character.

Embodiments in accordance with the present invention are directed to a bedding system comprising a comforter having one or more first three-dimensional elements, a pillow sham having one or more second three-dimensional elements, a throw pillow having one or more third three-dimensional elements and a body pillow having one or more fourth three-dimensional elements. Each of the comforter, the pillow sham, the throw pillow and the body pillow is shaped like a character. Further, each of the one or more first three-dimensional elements, each of the one or more second three-dimensional elements, each of the one or more third three-dimensional elements and each of the one or more fourth three-dimensional elements, is an attribute of the character and encloses a finite space.

Embodiments in accordance with the present invention are directed to a bedding system with components that are designed to match and complement each other. This provides a bedding system that provides an aesthetic appeal. The bedding system may be used as a learning tool for a user to correctly mix and match the components.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates front views of four bedding systems, each comprising a pillow sham and a comforter in accordance with embodiments disclosed herein;

FIG. 2 illustrates front views of various throw pillows with three-dimensional elements;

FIG. 3 illustrates front views of various body pillows with three-dimensional elements;

FIG. 4 illustrates a bedding system comprising a pillow sham, a throw pillow, a body pillow and a comforter in accordance with embodiments disclosed herein;

FIG. 5 illustrates a perspective view of a bedding system comprising a pillow sham and a comforter in accordance with embodiments disclosed herein;

FIG. 6 illustrates a perspective view of a throw pillow with three-dimensional elements such as a nose, a pair of ears, a pair of hands and a pair of legs; and

FIG. 7 illustrates a perspective view of a body pillow with three-dimensional elements such as hair, a pair of hands and a pair of legs.

While embodiments of the present invention are described herein by way of example using several illustrative drawings, those skilled in the art will recognize the present invention is not limited to the embodiments or drawings described. The drawings and the detailed description thereto are not intended to limit embodiments of the present invention to the particular form disclosed, but to the contrary, the present invention includes all modification, equivalents and alternatives falling within the spirit and scope of embodiments of the present invention as defined by the appended claims.

The headings used herein are for organizational purposes only and are intended to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be described below in conjunction with exemplary bedding systems. Embodiments of the present invention are not limited to any particular type of bedding systems. Those skilled in the art will recognize the disclosed embodiments may be used in any bedding system incorporating one or more three-dimensional (3D) elements.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” may be used interchangeably herein. The terms “comprising”, “including”, and “having” also may be used interchangeably.

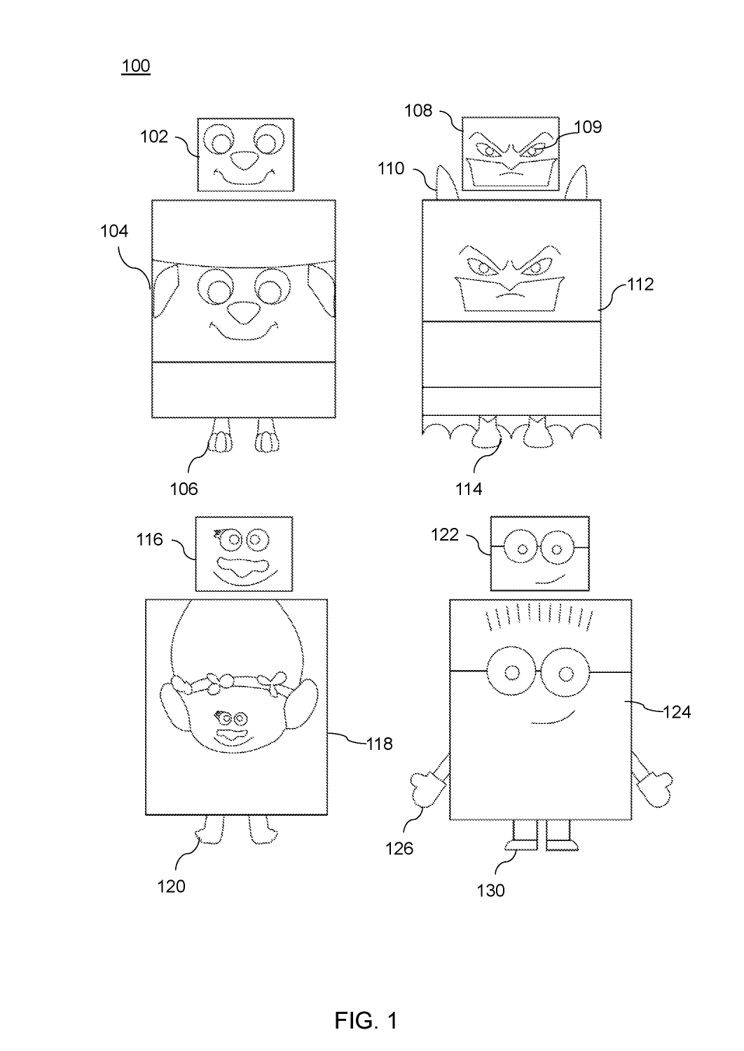

Embodiments of the present invention provide a bedding systems in the form of characters familiar to children or youth so as to make them aesthetically pleasing. FIG. 1 illustrates a front view of four bedding systems 100, each of which includes a pillow sham and a comforter. The pillow shams 102, 108, 116 and 122, as shown, may depict artwork of a fantasy character, a pet or an animal character. The pillow shams 102, 108, 116 and 122 are but not limited to a rectangular shape. In some embodiments, the pillow shams 102, 108, 116 and 122 are shaped as a character whose features form a theme of the corresponding bedding system. The pillow shams 102, 108, 116 and 122 may be used as a head rest decoration in a room or a house by placing it in a vertical position over a mantle or a sofa, a settee, a couch, a cabinet, or a bed. Further, pillow shams 102, 108, 116 and 122 may also be displayed in a vertical position in a display case to appeal to a potential customer. The pillow shams 102, 108, 116 and 122 may also be used as support when sitting in bed. They may be placed behind ordinary pillows when sleeping or just removed from the bed completely.

The comforters 104, 112, 118 and 124 include one or more first three-dimensional elements. As shown in FIG. 1, the one or more first three-dimensional elements may include, but are not restricted to, body parts such as eyes, arms, legs, nose, ears and hair. For instance, the comforter 104 includes a pair of legs 106, the comforter 112 includes a pair of legs 114 and a pair of ears 110, the comforter 118 includes a pair of legs 120 and the comforter 124 includes a pair of arms 126 and a pair of legs 130. Each of the pairs of legs, pairs of arms, pairs of ears, pairs of ears and the like are examples of the first three-dimensional elements, and collectively these character attributes form a theme of the corresponding bedding system. In some embodiments, the comforters 104, 112, 118 and 124 include a plurality of layers of batting enclosed within a pillow cover shaped as the character.

In some embodiments, the pillow shams 102, 108, 116 and 122 may include one or more three-dimensional elements that may be, but are not restricted to, eyes, arms, legs, nose, ears and hair. For instance, the pillow sham 108 includes a pair of eyes 109 that may be detachable elements. In some embodiments, the pair of eyes 109 may be made of wood or metal with a Velcro® hook and loop fastener or buttons that fasten the pair of eyes 109 to the pillow sham 108. In other embodiments, the pair of eyes 109 may be part of the pillow sham 108 while providing depth of view, thereby making the pair of eyes 109 three-dimensional.

The pillow shams 102, 108, 116 and 122 and the comforters 104, 112, 118 and 124 may display features related to any character, and are not restricted to the characters displayed in FIG. 1. Each set of pillow sham and comforter, i.e., the pillow sham 102 and the comforter 104, the pillow sham 108 and the comforter 112, the pillow sham 116 and the comforter 118, and the pillow sham 122 and the comforter 124, represents only one character and its features, including artwork and three-dimensional elements attributed to the one character.

The pillow shams 102, 108, 116 and 122 may include an internal filler, that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof. The filler may be placed in a cover made of wool, silk, cotton or cotton-linen blends. The cover may represent a fantasy character, an animal or a pet character, or the cover with filler may be placed in an outer cover with an opening through which the cover encasing the filler may be placed. The opening may be closeable with a zipper or Velcro® hook and loop fastener. The outer cover may represent any character. The dimensions and shapes of the cover encasing the filler and the outer cover are customized to the shapes of the pillow shams 102, 108, 116 and 122.

The first and second three-dimensional elements 106, 109, 114, 110, 120, 126 and 130 enclose a finite space and may include an internal filler that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof. Alternatively, the finite space may be filled with a fluid or gas, such as air.

In some embodiments, the first and second three-dimensional elements 106, 109, 114, 110, 120, 126 and 130 may be detachable elements and are connected to a respective comforter and/or pillow sham through a fastening mechanism. The fastening mechanism may include at least one of a Velcro® hook and loop fastener, a snap fastener, lace straps, and a zip fastener. The first and second three-dimensional elements 106, 109, 114, 110, 120, 126 and 130 also may be connected to the respective comforter and/or pillow sham using a tricot binding. In such cases, the first and second three-dimensional elements 106, 109, 114, 110, 120, 126 and 130 may be stitched to the seam of the respective pillow sham and/or comforter.

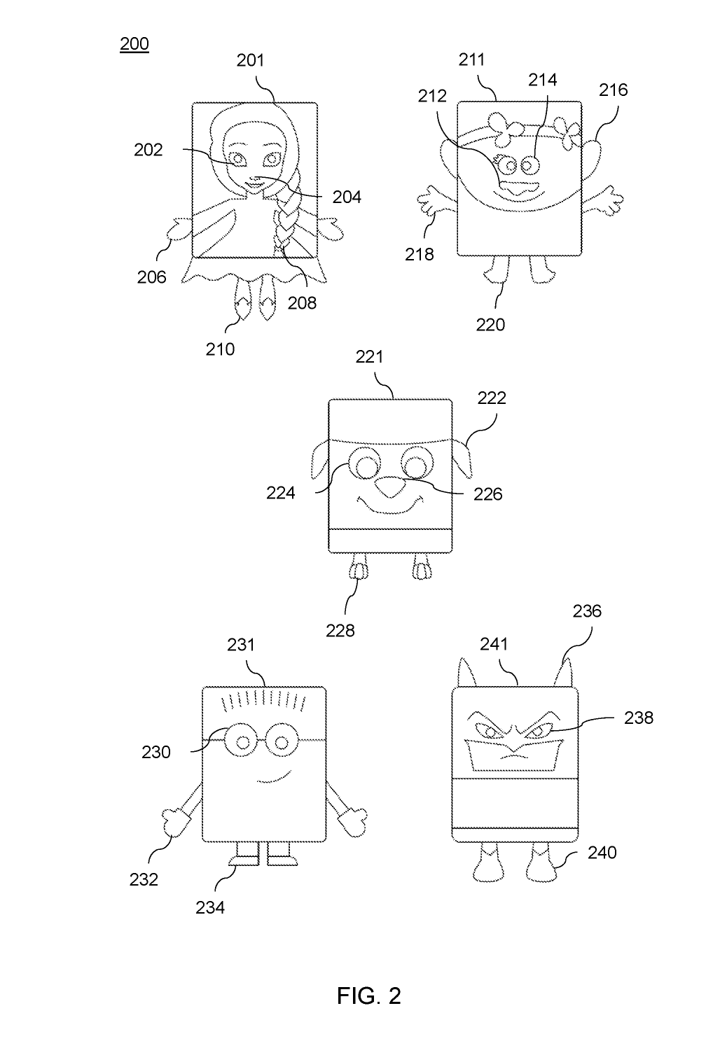

Embodiments of the present invention provide throw pillows 200 as shown in FIG. 2. The throw pillows 200 may take the form of familiar characters, e.g., pop-culture, fantasy, pet or animal characters. FIG. 2 illustrates throw pillows 201, 211, 221, 231 and 241, each throw pillow including one or more third three-dimensional elements. The throw pillows of FIG. 2 belong to a bedding system that features the same character as that of the throw pillow. For example, the throw pillow 241 features a specific character and is part of a bedding system that features the same character in its artwork, covers and three-dimensional elements. In some embodiments, each throw pillow may be part of a bedding system that also includes a comforter, a pillow sham and a body pillow. For instance, the throw pillow 241 is part of the bedding system that also features the pillow sham 108 and the comforter 112.

The third three-dimensional elements may include, but are not restricted to, eyes, arms, legs, nose, ears and hair. As shown in FIG. 2, the three-dimensional elements may be a pair of arms 206, 218 and 232, a pair of legs 210, 220, 228, 234 and 240, a pair of eyes 202, 214, 224, 230 and 238, a pair of ears 216, 222 and 236, a nose 204, 212 and 226, and hair 208. The third three-dimensional elements 202, 204, 206, 208, 210, 212, 214, 216, 218, 220, 222, 224, 226, 228, 230, 232, 234, 236, 238 and 240 enclose a finite space and may include an internal filler that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof.

In some embodiments, the third three-dimensional elements 202, 204, 206, 208, 210, 212, 214, 216, 218, 220, 222, 224, 226, 228, 230, 232, 234, 236, 238 and 240 may be detachable elements and are connected to the respective throw pillow through a fastening mechanism that may include at least one of a Velcro® hook and loop fastener, a snap fastener, lace straps, and a zip fastener. The third three-dimensional elements 202, 204, 206, 208, 210, 212, 214, 216, 218, 220, 222, 224, 226, 228, 230, 232, 234, 236, 238 and 240 also may be connected to the respective throw pillow using a tricot binding. In such cases, the third three-dimensional elements 202, 204, 206, 208, 210, 212, 214, 216, 218, 220, 222, 224, 226, 228, 230, 232, 234, 236, 238 and 240 may be stitched to the seam of the respective pillow sham and/or comforter.

The throw pillows 201, 211, 221, 231 and 241 may include an internal filler, that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof. The filler may be placed in a cover made of wool, silk, cotton or cotton-linen blends. The cover may represent a fantasy character, an animal or a pet character, or the cover with filler may be placed in an outer cover with a slit, an opening through which the cover encasing the filler may be placed. The opening may be closeable with a zipper or Velcro® hook and loop fastener. The outer cover may represent any character. The dimensions and shapes of the cover encasing the filler and the outer cover are customized to the shapes of the throw pillows 201, 211, 221, 231 and 241.

As shown in FIG. 2, the third three-dimensional elements 202, 204, 206, 208, 210, 212, 214, 216, 218, 220, 222, 224, 226, 228, 230, 232, 234, 236, 238 and 240 may be eyes, arms, legs, nose, ears and hair. Each of the pairs of legs, pairs of ears, pairs of ears, nose and hair are character attributes that inspired the corresponding bedding system. For instance, the pair of ears 236 is distinct to the character featured on the throw pillow 241 and is different from the pair of ears 222 that is distinct to the character featured on the throw pillow 221.

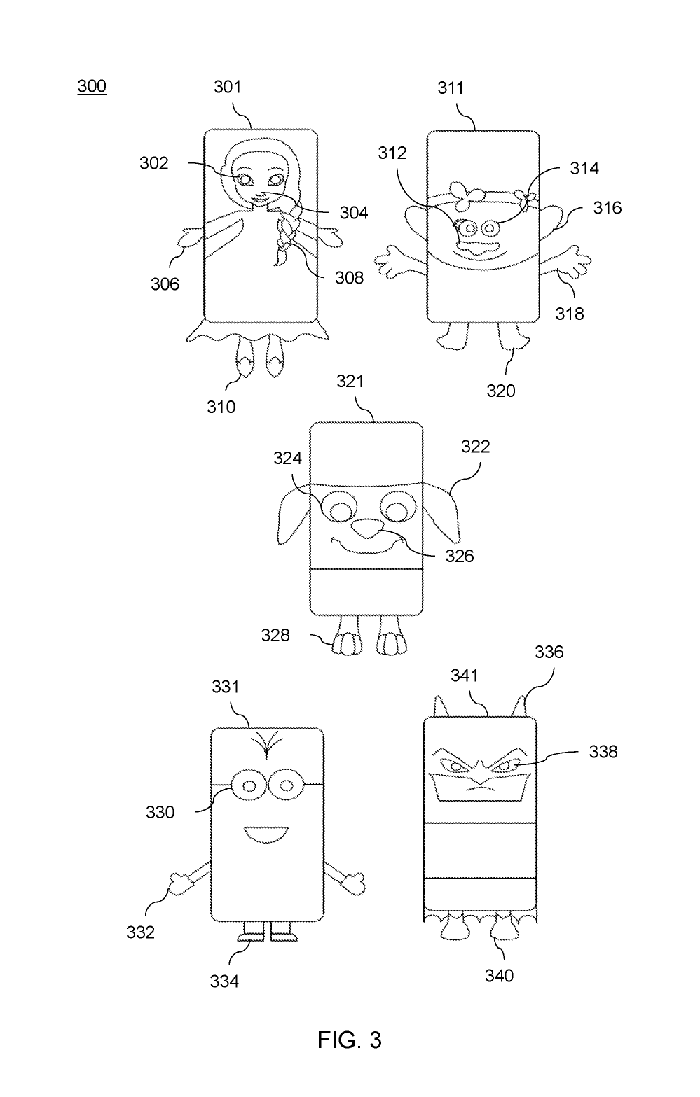

Embodiments of the present invention provide body pillows 300, as shown in FIG. 3. The body pillows 300 may take the form of familiar characters, e.g., pop-culture, fantasy, pets or animal characters. FIG. 3 illustrates body pillows 301, 311, 321, 331 and 341, each body pillow including one or more fourth three-dimensional elements. The body pillows of FIG. 3 belong to a bedding system that features the same character as that of the body pillow. For example, the body pillow 341 features a specific character and is part of a bedding system that features the same character theme in its artwork, covers and three-dimensional elements. In some embodiments, each body pillow may be part of a bedding system that also includes a comforter, a pillow sham and a throw pillow. For instance, the body pillow 341 is a part of the bedding system that also features the pillow sham 108, the comforter 112 and the throw pillow 241.

The fourth three-dimensional elements may include, but are not restricted to, eyes, arms, legs, nose, ears and hair. As shown in FIG. 3, the three-dimensional elements may be a pair of arms 306, 318 and 332, a pair of legs 310, 320, 328, 334 and 340, a pair of eyes 302, 314, 324, 330 and 338, a pair of ears 316, 322 and 336, a nose 304, 312 and 326, and hair 308. The fourth three-dimensional elements 302, 304, 306, 308, 310, 312, 314, 316, 318, 320, 322, 324, 326, 328, 330, 332, 334, 336, 338 and 340 enclose a finite space and may include an internal filler that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof.

In some embodiments, the fourth three-dimensional elements 302, 304, 306, 308, 310, 312, 314, 316, 318, 320, 322, 324, 326, 328, 330, 332, 334, 336, 338 and 340 may be detachable elements and are connected to the respective body pillow through a fastening mechanism that may include at least one of a Velcro® hook and loop fastener, a snap fastener, lace straps, and a zip fastener. The fourth three-dimensional elements 302, 304, 306, 308, 310, 312, 314, 316, 318, 320, 322, 324, 326, 328, 330, 332, 334, 336, 338 and 340 also may be connected to the respective body pillow using a tricot binding. In such cases, the fourth three-dimensional elements 302, 304, 306, 308, 310, 312, 314, 316, 318, 320, 322, 324, 326, 328, 330, 332, 334, 336, 338 and 340 may be stitched to the seam of the respective body pillow.

The body pillows 301, 311, 321, 331 and 341 may include an internal filler, that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof. The filler may be placed in a cover made of wool, silk, cotton or cotton-linen blends. The cover may represent a fantasy character, an animal or a pet character, or the cover with filler may be placed in an outer cover with an opening through which the cover encasing the filler may be placed. The opening may be closeable with a zipper or Velcro® hook and loop fastener. The outer cover may represent any character. The dimensions and shapes of the cover encasing the filler and the outer cover are customized to the shapes of the body pillows 301, 311, 321, 331 and 341.

As shown in FIG. 3, the fourth three-dimensional elements 302, 304, 306, 308, 310, 312, 314, 316, 318, 320, 322, 324, 326, 328, 330, 332, 334, 336, 338 and 340 may be eyes, arms, legs, nose, ears and hair. Each of the pairs of legs, pairs of ears, pairs of ears, nose and hair are character attributes that inspired the corresponding bedding system. For instance, the pair of ears 336 is distinct to the character featured on the body pillow 341 and is different from the pair of ears 322 that is distinct to the character featured on the body pillow 321.

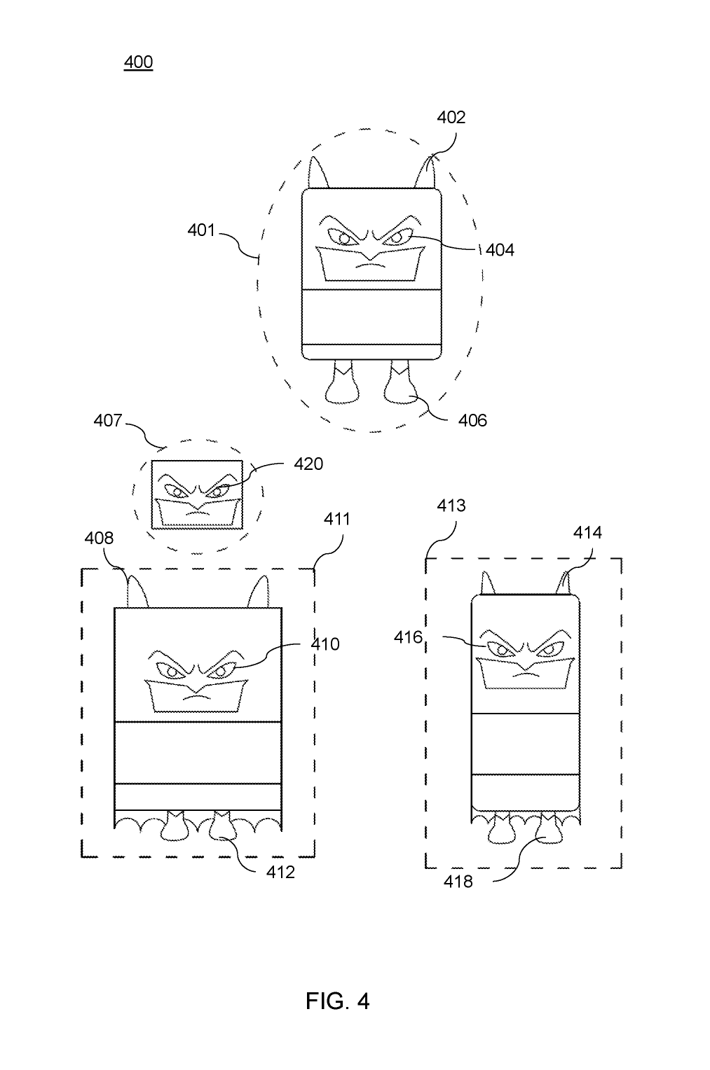

As shown in FIG. 4, embodiments of the present invention provide a bedding system 400 that includes a throw pillow 401, a pillow sham 407, a comforter 411 and a body pillow 413. The bedding system 400 includes three-dimensional elements attributed to a specific character, such as, but not restricted to, pairs of ears 402, 408 and 414, pairs of eyes 404, 410, 416 and 420, and pairs of legs 406, 412 and 418. The throw pillow 401, the pillow sham 407, the comforter 411 and the body pillow 413 may be used together or independently. When used together, the throw pillow 401, the pillow sham 407, the comforter 411 and the body pillow 413 may be designed to match and complement each other for an aesthetic combination bedding system. To match and complement each other may mean, for example, that the items have in common a design element such as a color, an artistic or aesthetic design incorporating the color, usage of multiple colors known to be pleasing in combination (such as known by a color wheel), a choice of material, and so forth. The bedding system 400 may be used as a learning tool for a user (for example, a child) to correctly mix and match the components.

The throw pillow 401, the body pillow 413 and the pillow sham 407 may include an internal filler, that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof. The filler may be placed in a cover made of wool, silk, cotton or cotton-linen blends. The cover may represent a fantasy character, an animal or a pet character, or the cover with filler may be placed in an outer cover with an opening through which the cover encasing the filler may be placed. The opening may be closeable with a zipper or Velcro® hook and loop fastener. The outer cover may represent any character. The three-dimensional elements 402, 404, 406, 408, 410, 412, 414, 416, 418 and 420 enclose a finite space and may include an internal filler that may be made from foam, synthetic fibers, feathers, down, viscoelastic foam, wool, polyester staple fiber, cotton, plastic tubes, Poly-Vinyl Chloride (PVC) pellets, expanded polystyrene, a granular material such as dried beans, expanded polypropylene, or a combination thereof.

In some embodiments, the three-dimensional elements 402, 404, 406, 408, 410, 412, 414, 416, 418 and 420 may be detachable elements and are connected to the respective body pillow through a fastening mechanism that may be at least one of a Velcro® hook and loop fastener, a snap fastener, lace straps, and a zip fastener. The three-dimensional elements 402, 404, 406, 408, 410, 412, 414, 416, 418 and 420 also may be connected to the respective body pillow, pillow sham and/or throw pillow using a tricot binding. In such cases, the three-dimensional elements 402, 404, 406, 408, 410, 412, 414, 416, 418 and 420 may be stitched to a seam of the respective body pillow.

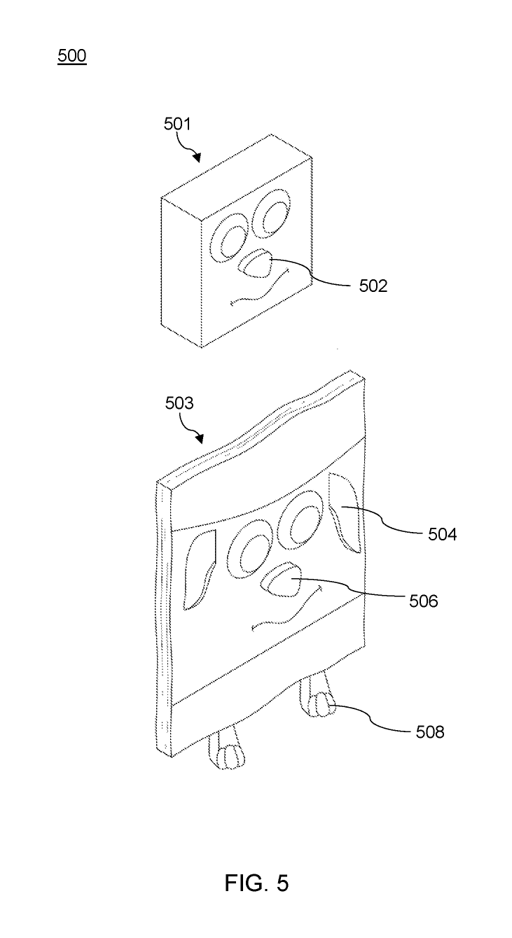

As shown in FIG. 5, embodiments of the present invention provide a perspective view of a bedding system 500 with a pillow sham 501 and a comforter 503, both featuring a specific character. The pillow sham 502 includes a three-dimensional element that includes a nose 502. The nose 502 encloses a finite space and may include an internal filler that may be made from foam, synthetic fibers, feathers, down, viscoelastic foam, wool, polyester staple fiber, cotton, plastic tubes, expanded polystyrene, a granular material such as dried beans, expanded polypropylene, or a combination thereof. The finite space may alternatively be filled with a fluid or gas, such as air.

The comforter 503 includes three-dimensional elements such as a pair of eyes 504, a nose 506 and a pair of legs 508. As with the nose 502, the pair of eyes 504, a nose 506 and a pair of legs 508 also enclose a finite space and may include an internal filler. The three-dimensional elements 502, 504, 506 and 508 are shown coming out of the pillow sham 501 and comforter 503, respectively. In some embodiments, the bedding system 500 also may further include a throw pillow and a body pillow with artwork and three-dimensional elements that are attributes to the same character.

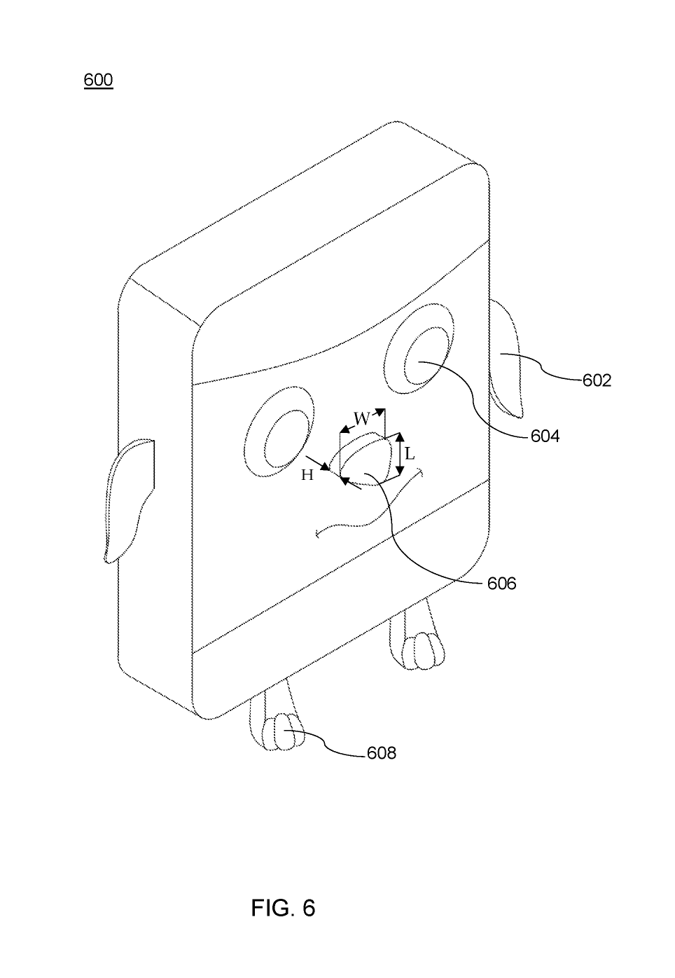

As shown in FIG. 6, embodiments of the present invention provide a perspective view of a throw pillow 600 featuring a character. The throw pillow 600 includes three-dimensional elements that may include a pair of ears 602, a pair of eyes 604, a nose 606 and a pair of legs 608. As with the three-dimensional elements included with the bedding system 500, the pair of ears 602, the pair of eyes 604, the nose 606 and the pair of legs 608 also enclose a finite space and may include an internal filler. The three-dimensional elements 602, 604, 606 and 608 are shown coming out of the pillow sham and comforter respectively. For instance, FIG. 6 also illustrates the nose 606 having a width ‘W’, a thickness ‘H’ and a length ‘L’. In some embodiments, the throw pillow 600 may be part of a bedding system that includes a comforter, a pillow sham and a body pillow with artwork and three-dimensional elements that are attributes to the same character.

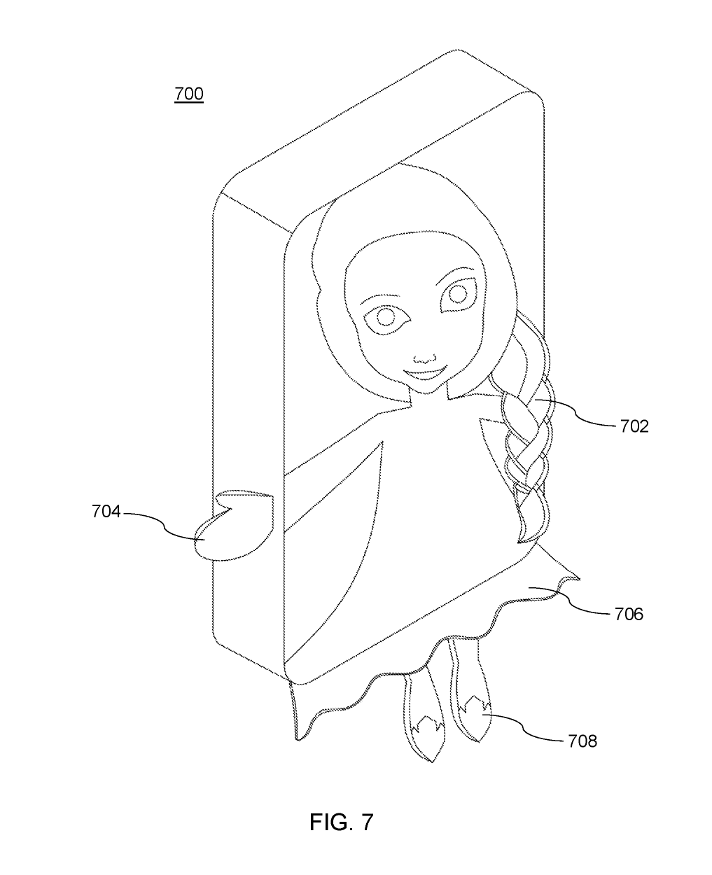

As shown in FIG. 7, embodiments of the present invention provide a perspective view of a body pillow 700 featuring a character. The body pillow 700 includes three-dimensional elements that may include hair 702, a pair of hands 704, and a pair of legs 706. As with the three-dimensional elements included with the bedding system 500 and throw pillow 600, the hair 702, the pair of hands 704, a dress 706 and the pair of legs 708 also encloses a finite space and may include an internal filler. The three-dimensional elements 702, 704, 706 and 708 mimic the distinctive features of the character. Further, the three-dimensional elements 702, 704, 706 and 708 are shown coming out of the body pillow. In some embodiments, the body pillow 700 may be part of a bedding system that includes a throw pillow, a comforter and a pillow sham with artwork and three-dimensional elements that are attributes to the same character.

The exemplary embodiments of this present invention have been described in relation to bedding systems. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention may be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect.

Moreover, though the description of the present invention has included the description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A bedding system comprising:
a comforter comprising one or more first three-dimensional elements;
a pillow sham comprising one or more second three-dimensional elements; and
a throw pillow comprising one or more third three-dimensional elements;
wherein each of the comforter, the pillow sham and the throw pillow is shaped like a character, and
wherein each of the one or more first three-dimensional elements, each of the one or more second three-dimensional elements and each of the one or more third three-dimensional elements comprises a respective attribute of the character.

2. The bedding system of claim 1, wherein each of the one or more first three-dimensional elements, the one or more second three-dimensional elements and the one or more third three-dimensional elements encloses a finite space and comprises at least one of arms, legs, nose, ears and hair.

3. The bedding system of claim 2, wherein the finite space is filled with a filler material.

4. The bedding system of claim 1, further comprising a body pillow shaped like the character, the body pillow further comprising one or more fourth three-dimensional elements representative of the character.

5. The bedding system of claim 4, wherein the one or more fourth three-dimensional elements comprises at least one of arms, legs, nose, ears and hair.

6. The bedding system of claim 1, wherein the comforter further comprises a plurality of layers of batting.

7. The bedding system of claim 1, wherein each of the comforter, the pillow sham and the throw pillow further comprises a tricot binding configured to connect the corresponding one or more three-dimensional elements thereon.

8. The bedding system of claim 1, wherein each of the comforter, the pillow sham and the throw pillow further comprises a fastening mechanism configured to connect the corresponding one or more three-dimensional elements thereon.

9. The bedding system of claim 8, wherein the fastening mechanism comprises a fastener selected from a group consisting of a hook and loop fastener, a snap fastener, lace straps and a zip fastener.

10. The bedding system of claim 1, wherein the comforter, the pillow sham and the throw pillow are configured to match and complement each other.

11. A bedding system comprising:
a comforter comprising one or more first three-dimensional elements;
a pillow sham comprising one or more second three-dimensional elements;
a throw pillow comprising one or more third three-dimensional elements; and
a body pillow comprising one or more fourth three-dimensional elements;
wherein each of the comforter, the pillow sham, the throw pillow and the body pillow is shaped like a character, and
wherein each of the one or more first three-dimensional elements, each of the one or more second three-dimensional elements, each of the one or more third three-dimensional elements and each of the one or more fourth three-dimensional elements comprises a respective attribute of the character.

12. The bedding system of claim 11, wherein each of the one or more first three-dimensional elements, the one or more second three-dimensional elements and the one or more third three-dimensional elements encloses a finite space and comprises at least one of arms, legs, nose, ears and hair.

13. The bedding system of claim 12, wherein the finite space is filled with a filler material.

14. The bedding system of claim 11, wherein each of the comforter, the pillow sham, the throw pillow and the body pillow further comprises a tricot binding configured to connect the corresponding one or more three-dimensional elements thereon.

15. The bedding system of claim 11, wherein each of the comforter, the pillow sham, the throw pillow and the body pillow further comprises a fastening mechanism configured to connect the corresponding one or more three-dimensional elements thereon.

16. The bedding system of claim 11, wherein the fastening mechanism comprises a fastener selected from a group consisting of a hook and loop fastener, a snap fastener, lace straps and a zip fastener.

17. The bedding system of claim 11, wherein each of the one or more first three-dimensional elements, each of the one or more second three-dimensional elements, each of the one or more third three-dimensional elements and each of the one or more fourth three-dimensional elements encloses a finite space.

18. The bedding system of claim 17, wherein each of the comforter, the pillow sham, the throw pillow and the body pillow further comprises a tricot binding configured to connect the corresponding one or more three-dimensional elements thereon.

19. The bedding system of claim 17, wherein each of the comforter, the pillow sham, the throw pillow and the body pillow further comprises a fastening mechanism configured to connect the corresponding one or more three-dimensional elements thereon.
